(19) United States
(12) Patent Application Publication
(10) Pub. No.: US 2011/0184926 A1
(43) Pub. Date: Jul. 28, 2011

(54) EXPERT LIST RECOMMENDATION METHODS AND SYSTEMS

(75) Inventors: Hahn-Ming LEE, Taipei City (TW); Jan-Ming HO, Taipei City (TW); Jerome YEH, Taipei City (TW); Kai-Hsiang YANG, Taipei City (TW); Tai-Liang KUO, Taipei City (TW); Chun-Han CHEN, Taipei City (TW)

(73) Assignee: NATIONAL TAIWAN UNIVERSITY OF SCIENCE & TECHNOLOGY, Taipei City (TW)

(21) Appl. No.: 12/823,181

(22) Filed: Jun. 25, 2010

(30) Foreign Application Priority Data
Jan. 26, 2010 (TW) 099102048

(51) Int. Cl. G06F 17/30

(52) U.S. Cl. 707/706; 707/738; 707/731; 707/739; 707/E17.108; 707/E17.047

(57) ABSTRACT

An expert list recommendation system is provided, including: a domain modeler for establishing an expert knowledge database according to a plurality of expert publications in different domains, receiving an inquired proposal, determining the academic field of the inquired proposal according to keywords of the inquired proposal and keyword sets of the expert publications in different domains stored in the expert knowledge database, and outputting a first domain expert list corresponding to the inquired proposal, wherein the first domain expert list comprises a first group of expert publications and a first group of expert names; and an expertise matcher for receiving the first domain expert list, comparing semantic relatedness between keywords of the inquired proposal and keywords corresponding to the first group of the expert publications of the first domain expert list to output a first expert list to a display device.

### CROSS REFERENCE TO RELATED APPLICATIONS

This Application claims priority of Taiwan Patent Application No. 099102048 filed on Jan. 26, 2010, the entirety of which is incorporated by reference herein.

### BACKGROUND OF THE APPLICATION

1. Technical Field

The application relates to analysis and identification methods and systems, and more particularly, to methods and systems for recommending an expert list by collaborative intelligence.

2. Related Art

Recently, most methods for recommending an expert list are based on the number of times the writing content of an expert appears in an inquired proposal. However, normally, the expert list contains experts in only one specific domain. Accordingly, most research reports and documents of different domains are not identified and included in the analysis.

Current expert list methods suffer from the following problems. First, for multiple domains, the number of times the writing content of an expert appears in an inquired proposal is normally larger than that of a specific domain; thus, keywords calculated by current expert list methods do not meet requirements for multiple domain application. Second, because advanced classification of expert publications are not performed by current expert list methods, much time is required when reviewing and comparing information which may not be relevant. Therefore, efficiency for system performance is poor.

Furthermore, different domains use different technical expressions, such as the word “calculating machine” and the word “computer”; which are actually equivalent meanings. Therefore, it is very difficult to manually or automatically construct and maintain a semantic network between different domains.

Therefore, in order to solve the above-mentioned problem, the invention provides expert list recommendation methods and systems which may cover different domains, have high comparing efficiency, and effectively maintain a semantic network.

### BRIEF SUMMARY OF THE APPLICATION

One aspect of the invention is to provide an expert list recommendation system, comprising: a domain modeler for establishing an expert knowledge database according to a plurality of expert publications in different domains, receiving an inquired proposal, determining the academic field of the inquired proposal according to keywords of the inquired proposal and keyword sets of the expert publications in different domains stored in the expert knowledge database, and outputting a first domain expert list corresponding to the inquired proposal, wherein the first domain expert list comprises a first group of expert publications and a first group of expert names; and an expertise matcher for receiving the first domain expert list, comparing semantic relatedness between keywords of the inquired proposal and keywords of the first group of the expert publications corresponding to the first domain expert list to output a first expert list to a display device.

Another aspect of the invention is to provide an expert list recommendation method, comprising: providing a plurality of expert publications in a different domains; establishing an expert knowledge database according to keywords of the expert publications in different domains by a domain modeler, receiving an inquired proposal; determining the academic field of the inquired proposal according to keywords of the inquired proposal and keyword sets of the keywords of the expert publications in different domains stored in the expert knowledge database; outputting a first domain expert list corresponding to the inquired proposal, wherein the first domain expert list comprises a first group of expert publications and a first group of expert names; receiving the first domain expert list; comparing semantic relatedness between keywords of the inquired proposal and keywords of the first group of the expert publications corresponding to the first domain expert list to generate a first expert list; and outputting the first expert list to a display device.

Another aspect of the invention is to provide an expert list recommendation method, comprising: providing a plurality of online communities, wherein subject matters of the online communities are related to different domains; establishing a semantic network according to phraseology keywords and technical expressions used and communicated by social network users of online communities; storing the semantic network in an expert knowledge database; receiving an inquired proposal; outputting an expert name list and expert publications of the academic field related to the inquired proposal according to keywords of the proposed title of the inquired proposal by checking the expert knowledge database; comparing semantic relatedness between the inquired proposal and the expert name list and the expert publications of the academic field related to the inquired proposal to generate an expert list; and displaying the expert list in a display device.

The advantage and spirit of the invention may be better understood by the following recitations and the appended drawings.

### BRIEF DESCRIPTION OF DRAWINGS

The invention can be more fully understood by reading the subsequent detailed description and examples with references made to the accompanying drawings, wherein:

FIG. 1 is a block diagram illustrating an expert list recommendation system 10 according to an embodiment of the invention.

FIG. 2 is a schematic diagram illustrating the relatedness and the depth according to an embodiment of the invention.

FIG. 3 is a block diagram illustrating an expertise matcher 103 according to an embodiment of the invention.

FIG. 4 is a block diagram illustrating a ranking device 104 according to an embodiment of the invention.

FIG. 5 is a flow chat illustrating an expert list recommendation method according to an embodiment of the invention.

FIG. 6 is a flow chat illustrating another expert list recommendation method according to an embodiment of the invention.

### DETAILED DESCRIPTION

The following description may be a contemplated mode of carrying out the invention. This description is made for the purpose of illustrating the general principles of the invention and should not be taken in a limiting sense. The scope of the invention is best determined by reference to the appended claims.

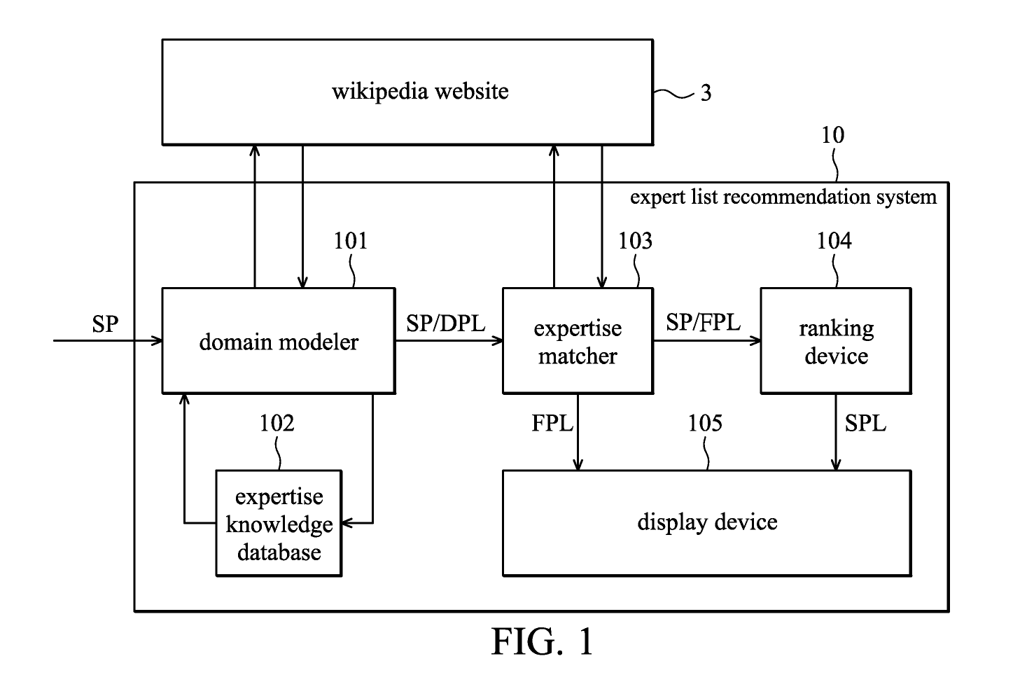

FIG. 1 is a block diagram illustrating an expert list recommendation system 10 according to an embodiment of the invention. The expert list recommendation system 10 comprises a domain modeler 101, an expert knowledge database 102, an expertise matcher 103, a ranking device 104 and a display device 105.

The domain modeler 101 receives a plurality of expert publications in different domains, and establishes the expert knowledge database 102 according to keywords of the tiles in the expert publications in different domains by collecting wikipedia page titles (WPTs) corresponding keywords of the tiles in the expert publications in different domains by a wikipedia website 3. Therefore, the expert knowledge database 102 stores the keyword sets of the expert publications in a different domain and wikipedia page titles corresponding to the keyword sets of the expert publications in different domains.

The domain modeler 101 receives an inquired proposal SP, when the domain modeler 101 has already estimated the expert knowledge database 102. The domain modeler 101 then collects wikipedia page titles corresponding to the keywords of the titles of the inquired proposal SP according to the keywords of the titles of the inquired proposal SP by checking the wikipedia website 3.

The domain modeler 101 determines whether the inquired proposal belongs to an academic field according to wikipedia page titles corresponding to the inquired proposal SP and wikipedia page titles corresponding to the keyword sets of the expert publications in different domains stored in the expert knowledge database. A first domain expert list DPL corresponding to the determined academic field which the inquired proposal SP belongs to is output to the expertise matcher 103 by the domain modeler 101, wherein the first domain expert list DPL comprises a first group of expert publications and a first group of expert names.

The expertise matcher 103 in the expert list recommendation system 10 receives the first domain expert list DPL. The semantic relatedness between wikipedia page titles of the inquired proposal SP and wikipedia page titles of keywords of the first group of the expert publications corresponding to the first domain expert list DPL is compared to the wikipedia website 3 to seek relatedness and depth between the inquired proposal SP and the first domain expert list DPL.

The expertise matcher 103 generates a semantic net distance table SND according to the relatedness and the depth thereof. The depth represents classification category levels from a starting catalog of a wikipedia page (root directory) and the relatedness represents is a distance between the wikipedia page titles corresponding to the inquired proposal SP and the wikipedia page titles corresponding to first domain expert list DPL under the catalog structure of the wikipedia page in the wikipedia website 3, and also represents the quantified distribution between the wikipedia page titles corresponding to the inquired proposal SP and the wikipedia page titles corresponding to first domain expert list DPL under the catalog structure of the wikipedia page.

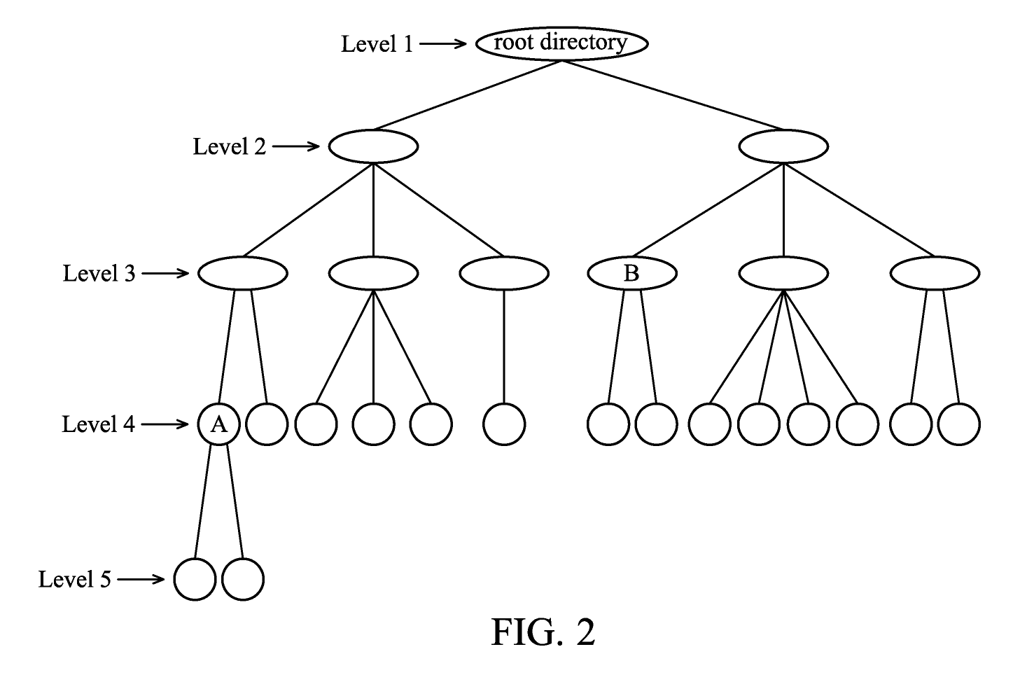

For example, the depth (levels) of Cathay General hospital is seven under the catalog structure of the wikipedia page (root directory, nature, life, health, hospital, Taiwan hospital, Cathay General hospital, the total amount of levels is seven). For another example, as shown in the FIG. 2, the depth of the wikipedia page title of keyword A is four under the catalog structure of the wikipedia page in the wikipedia website 3 which means the classification category level is four, and the depth of the wikipedia page title of keyword B is three under the catalog structure of the wikipedia page in the wikipedia website 3 which means the classification category level is three. The relatedness is obtained according to the following steps, such as seeking the largest depth between the wikipedia page titles (the depth of the wikipedia page title of keyword A is four in FIG. 2), seeking the shortest distance between keyword A and B under the catalog structure of the wikipedia page (the shortest distance of keyword A and B is five in the FIG. 2), calculating the relatedness according to the formula, −log {x/(2*y)}, wherein in this example parameter x represents the shortest distance such as x=5 and parameter y represents the largest depth such as y=4. Therefore, the relatedness equals to approximately 0.2 according to the formula and the parameters.

The expertise matcher 103 generates a first expert list FPL according to the semantic net distance table SND and outputs the first expert list FPL to the ranking device 104 and displays the first expert list FPL in the display device 105.

The ranking device 104 in the expert list recommendation system 10 estimates a ranking score table AS corresponding to the first expert list FPL according to the first expert list FPL and an academic authority score table PSS and outputs a second expert list SPL to the display device 105 according to the ranking score table AS.

Therefore, the expert list related to and closed to the inquired proposal SP is obtained by the expert list recommendation system 10. The problems associated with multi-word meanings or multi-word uses may be avoided by comparing wikipedia page titles of keywords in the exemplary embodiment of the invention. For example, the expert list related to and closed to the proposal is obtained by the expert list recommendation system 10 to seek oral examination members according to the expert list and more easily seek highly related experts in the same domain to be oral examination members.

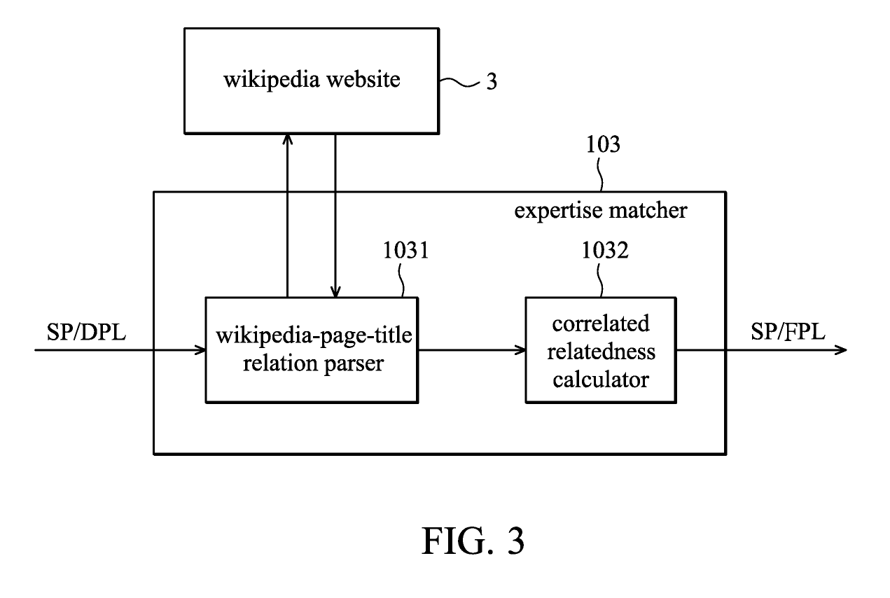

FIG. 3 is a block diagram illustrating an expertise matcher 103 according to an embodiment of the invention. The expertise matcher 103 further comprises a wikipedia-page-title relation parser 1031 and a correlated relatedness calculator 1032. The wikipedia-page-title relation parser 1031 receives the inquired proposal SP and the first domain expert list, and obtains relatedness and depth between the inquired proposal SP and the first domain expert list DPL according to the wikipedia page titles corresponding to the keywords of the tile in the inquired proposal SP and wikipedia page titles corresponding to the keywords of the tiles in the first domain expert list DPL by checking the wikipedia website 3 to generate a semantic net distance table SND. The depth represents classification category levels from a starting catalog of the wikipedia page (root directory) and the relatedness represents a distance between the wikipedia page titles corresponding to the inquired proposal SP and the wikipedia page titles corresponding to the first domain expert list DPL under the catalog structure of the wikipedia page in the wikipedia website 3. Therefore, the relatedness is larger when the distance is closer.

The correlated relatedness calculator 1032 quantifies the semantic net distance table SND, and outputs the related scores between the inquired proposal SP and the first domain expert list DPL (which are more similar, when the related scores are larger), wherein the related scores are defined as the first group expertise relatedness score table. The correlated relatedness calculator 1032 then generates the first expert list FPL according to the related scores such that the first expert list FPL comprises the first group expertise relatedness score table.

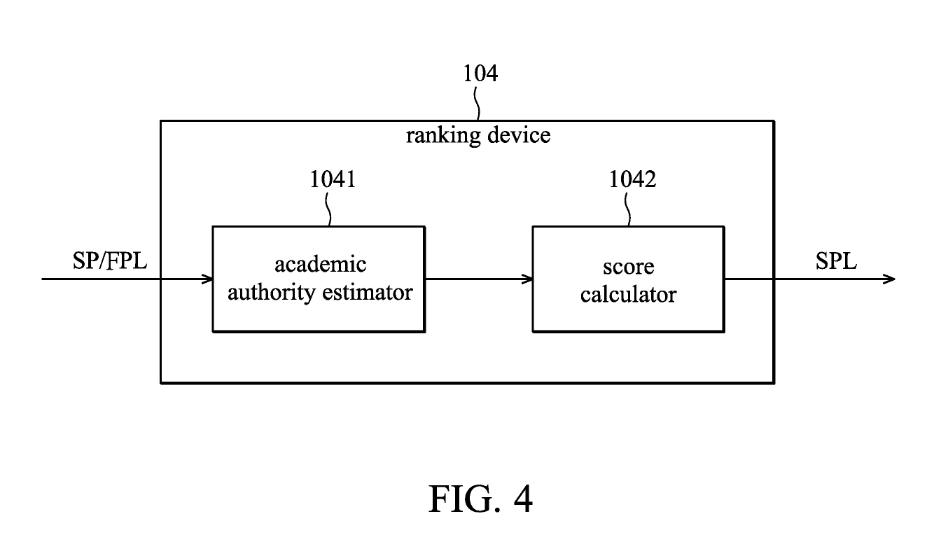

FIG. 4 is a block diagram illustrating a ranking device 104 according to an embodiment of the invention. The ranking device 104 further comprises an academic authority estimator 1041 and a score calculator 1042. The academic authority estimator 1041 obtains academic scores of experts related to the inquired proposal SP according to the first expert list FPL and the academic authority score table PSS.

The score calculator 1042 weights the first group expertise relatedness score table of the first expert list FPL and the academic scores of the experts related to the inquired proposal to calculate the ranking score table AS corresponding to the first expert list FPL, and arranges expert names in order according to scores of the ranking score table AS. Several expert names and corresponding expert publications with higher scores on the ranking score table AS are chosen to generate the second expert list SPL, and the second expert list SPL is displayed in the display device 105.

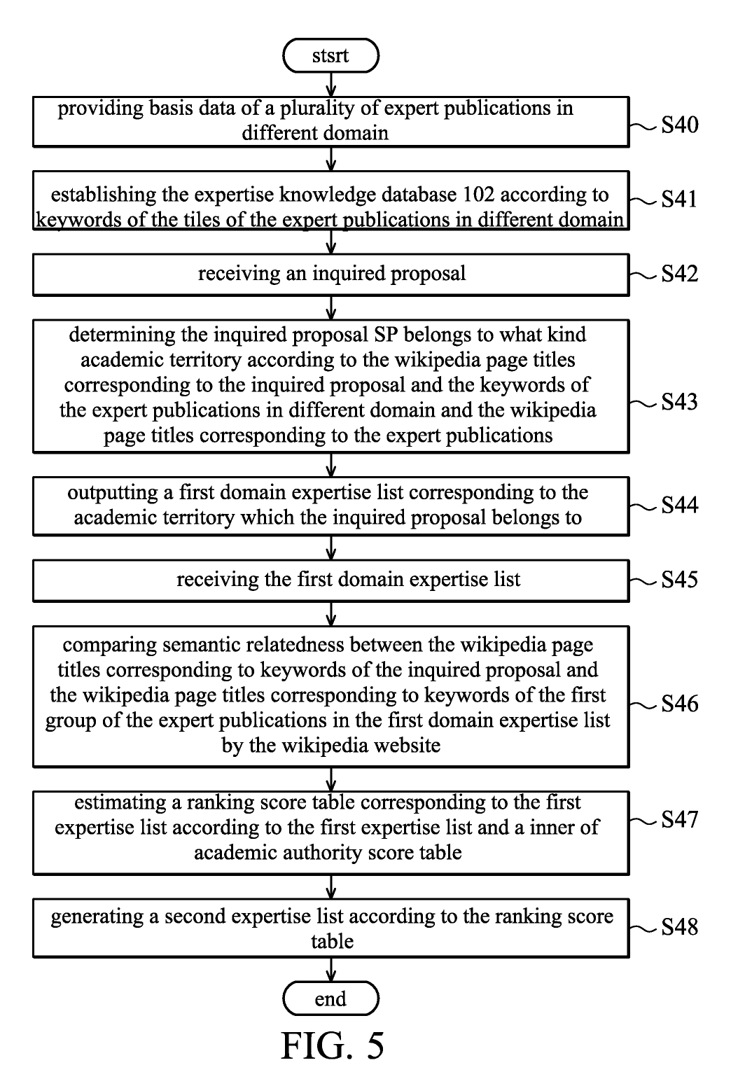

FIG. 5 is a flow chat illustrating an expert list recommendation method according to an embodiment of the invention. The expert list recommendation method may comprises: providing the fundamental data of a plurality of expert publications in different domains such as tile, authors and publication data of expert publications etc. (step S40); establishing the expert knowledge database 102 according to keywords of the tiles, authors and publication data of the expert publications in different domains by the domain modeler 101 and checking the wikipedia website 3 (step S41), wherein the expert knowledge database 102 stores sets of keywords of the tiles of the expert publications in a different domain and the wikipedia page titles corresponding to keywords of the tiles of the expert publications in different domains; in step S42; receiving an inquired proposal SP when the expert knowledge database 102 has been established; in step S43; determining that the inquired proposal SP belongs to an academic field according to the wikipedia page titles corresponding to the keywords of the tile in the inquired proposal SP and the sets of the keywords of the expert publications in a different domain and the wikipedia page titles corresponding to them stored in the expert knowledge database 102. For example, when the tile in the inquired proposal SP “Reducing Carrier Frequency Offset in Orthogonal Frequency Division Multiplexing System” is received, the domain modeler 101 collects/extracts keywords corresponding to the tile in the inquired proposal SP such as the keywords “Orthogonal Frequency Division Multiplexing System” and “Carrier Frequency Offset” etc. The wikipedia page titles corresponding to the keywords “Orthogonal Frequency Division Multiplexing System” and “Carrier Frequency Offset” is obtained by the wikipedia website 3, and then the probabilities of the inquired proposal SP for academic field determination are obtained according to sets of keywords of the tiles of the expert publications in a different domain and the wikipedia page titles corresponding to keywords of the tiles of the expert publications in different domains stored by the expert knowledge database 102. The probabilities are arranged in order according to magnitudes of the probabilities. Therefore, the inquired proposal SP belongs to the academic field of wireless communication.

The expert list recommendation method comprises: outputting a first domain expert list DPL corresponding to the academic field which the inquired proposal SP belongs to (step S44), wherein the first domain expert list comprises the first group of expert publications and the first group of expert names: in step S45, receiving the first domain expert list DPL by the expertise matcher 103: in step S46, comparing semantic relatedness between the wikipedia page titles corresponding to keywords of the inquired proposal and the wikipedia page titles corresponding to keywords of the first group of the expert publications in the first domain expert list DPL to generate a first expert list FPL and display the first expert list FPL in display device 105; in step S47, estimating a ranking score table corresponding to the first expert list FPL according to the first expert list FPL and an academic authority score table by the ranking device 104; in step S48, generating a second expert list SPL according to the ranking score table and outputting the second expert list SPL to the display device 105, to complete the process.

The domain construction and expertise comparison using the wikipedia website is not limiting, and can be replaced by a semantic network according to phraseology keywords and technical expressions used and communicated by social network users of online communities.

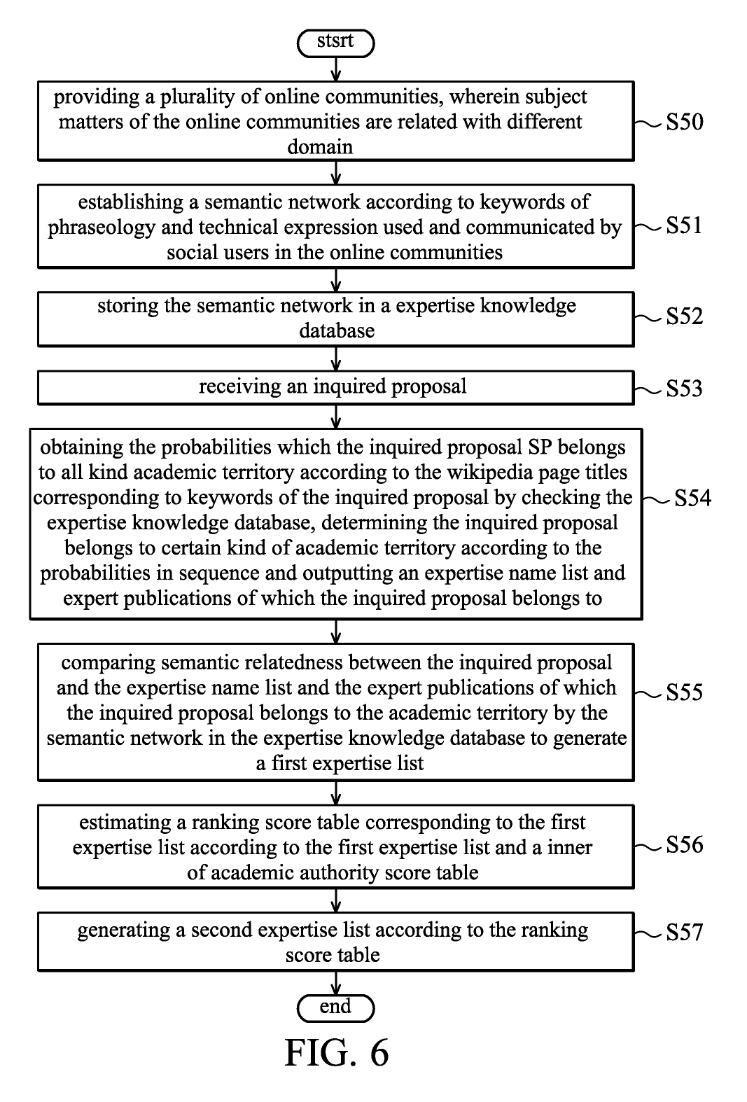

FIG. 6 is a flow chat illustrating another expert list recommendation method according to an embodiment of the invention. An expert list recommendation method comprises: in step S50, providing a plurality of online communities such as a network programming discussion, a network database, the famous online community “JAVA Forum”, community, wherein subject matters of the online communities are related to different domains; in step S51, establishing a semantic network according to phraseology keywords and technical expression used and communicated by social network users of online communities; in step S52, storing the semantic network in an expert knowledge database 102; in step S53, receiving an inquired proposal when the expert knowledge database 102 has been established; in step S54, obtaining the probabilities of the inquired proposal SP belonging to all kinds of academic field according to the wikipedia page titles corresponding to keywords of the inquired proposal by checking the expert knowledge database 102, and then determining the academic field or fields of the inquired proposal according to the probabilities in sequence and outputting an expert name list and expert publications of the academic field of the inquired proposal; in step S55, comparing semantic relatedness between the inquired proposal and the expert name list and the expert publications of the academic field related to the inquired proposal to generate a first expert list FPL, in other word, seeking the relatedness and the depth between the inquired proposal and the expert name list and the expert publications of the academic field related to the inquired proposal to generate a first expert list FPL by the semantic network in the expert knowledge database 102 which is analogous to the catalog structure of the wikipedia page in the wikipedia website 3; in step S56, estimating a ranking score table corresponding to the first expert list FPL according to the first expert list FPL and an academic authority score table by a ranking device 104; in step S57, generating a second expert list SPL according to the ranking score table and outputting the second expert list SPL to the display device 105, to complete the process.

After processing, the comparison range may be reduced to avoid unnecessary keyword comparisons with unrelated publications. Therefore, the invention can increase efficiency.

With the example and explanations above, the features and spirit of the invention are hopefully well described. Those skilled in the art will readily observe that numerous modifications and alterations of the embodiments may be made while retaining the teachings of the invention. Accordingly, the above disclosure should be construed as limited only by the metes and bounds of the appended claims.

What is claimed is:

1. An expert list recommendation system, comprising:
a domain modeler, establishing an expert knowledge database according to a plurality of expert publications in different domains, receiving an inquired proposal, determining the academic field of the inquired proposal according to keywords of the inquired proposal and keyword sets of the expert publications in different domains stored in the expert knowledge database, and outputting a first domain expert list corresponding to the inquired proposal, wherein the first domain expert list comprises a first group of expert publications and a first group of expert names; and
an expertise matcher, receiving the first domain expert list, comparing semantic relatedness between keywords of the inquired proposal and keywords corresponding to the first group of the expert publications of the first domain expert list to output a first expert list to a display device.

2. The expert list recommendation system of claim 1, further comprising:
a ranking device, estimating a ranking score table corresponding to the first expert list according to the first expert list and an academic authority score table, and outputting a second expert list to the display device according to the ranking score table.

3. The expert list recommendation system of claim 1, wherein the expert knowledge database stores the sets of keywords of the expert publications in a different domain and wikipedia page titles corresponding to the sets of keywords of the expert publications in different domains.

4. The expert list recommendation system of claim 1, wherein the domain modeler collects wikipedia page titles corresponding to the inquired proposal according to keywords of the inquired proposal by checking a wikipedia website, determines the academic field of the inquired proposal according to wikipedia page titles corresponding to the inquired proposal and wikipedia page titles corresponding to the keyword sets of the expert publications in different domains stored in the expert knowledge database, and outputting the first domain expert list corresponding to the determined academic field of the inquired proposal.

5. The expert list recommendation system of claim 1, wherein the expertise matcher further comprises:
a wikipedia-page-title relation parser, obtaining relatedness and depth between the inquired proposal and the first domain expert list according to the inquired proposal and the first domain expert list by checking the wikipedia website to generate a semantic net distance table; and
a correlated relatedness calculator, generating the first expert list according to the semantic net distance table, wherein the first expert list comprises a first group expertise relatedness score table.

6. The expert list recommendation system of claim 2, wherein the ranking device further comprises:
an academic authority estimator, obtaining academic scores of experts related to the inquired proposal according to the first expert list and the academic authority score table; and
a score calculator, weighting the first group expertise relatedness score table and the academic scores of the experts related to the inquired proposal, calculating the ranking score table corresponding to the first expert list, and outputting the second expert list according to the ranking score table.

7. An expert list recommendation method, comprising:
providing a plurality of expert publications in a different domains;
establishing an expert knowledge database according to keywords of the expert publications in different domains by a domain modeler,
receiving an inquired proposal;
determining the academic field of the inquired proposal according to keywords of the inquired proposal and keyword sets of the keywords of the expert publications in different domains stored in the expert knowledge database;
outputting a first domain expert list corresponding to the inquired proposal, wherein the first domain expert list comprises a first group of expert publications and a first group of expert names;
receiving the first domain expert list;
comparing semantic relatedness between keywords of the inquired proposal and keywords of the first group of the expert publications corresponding to the first domain expert list to generate a first expert list; and
outputting the first expert list to a display device.

8. The expert list recommendation method of claim 7, further comprising:
estimating a ranking score table corresponding to the first expert list according to the first expert list and an academic authority score table by a ranking device;
generating a second expert list according to the ranking score table; and
outputting the second expert list to the display device.

9. The expert list recommendation method of claim 7, wherein the expert knowledge database stores the keyword sets of the expert publications in a different domain and wikipedia page titles corresponding to the keyword sets of the expert publications in a different domains.

10. The expert list recommendation method of claim 7, wherein the domain modeler collects wikipedia page titles corresponding to the inquired proposal according to keywords of the inquired proposal by checking a wikipedia website, determines whether the academic field of the inquired proposal according to wikipedia page titles corresponding to the inquired proposal and wikipedia page titles corresponding to the keyword sets of the expert publications in different domains stored in the expert knowledge database, and outputs the first domain expert list corresponding to the determined academic field of the inquired proposal.

11. The expert list recommendation method of claim 7, wherein step of comparing semantic relatedness between keywords of the inquired proposal and keywords of the first group of the expert publications corresponding to the first domain expert list further comprises:
obtaining relatedness and depth between the inquired proposal and the first domain expert list according to the inquired proposal and the first domain expert list by checking the wikipedia website;
generating a semantic net distance table according to the relatedness and the depth between the inquired proposal and the first domain expert list; and
generating the first expert list according to the semantic net distance table, wherein the first expert list comprises a first group expertise relatedness score table.

12. The expert list recommendation method of claim 8, wherein step of estimation further comprises:
obtaining academic scores of experts related to the inquired proposal according to the first expert list and the academic authority score table;
weighting the first group expertise relatedness score table and the academic scores of the experts related to the inquired proposal to calculate the ranking score table corresponding to the first expert list; and
generating the second expert list according to the ranking score table.

13. An expert list recommendation method, comprising:
providing a plurality of online communities, wherein subject matters of the online communities are related to different domains;
establishing a semantic network according to phraseology keywords and technical expressions used and communicated by social network users of online communities;
storing the semantic network in an expert knowledge database;
receiving an inquired proposal;
outputting an expert name list and expert publications of the academic field of the inquired proposal according to keywords of the proposed title of the inquired proposal by checking the expert knowledge database;
comparing semantic relatedness between the inquired proposal and the expert name list and the expert publications of the academic field of the inquired proposal to generate an expert list; and
displaying the expert list in a display device.

14. The expert list recommendation method of claim 13, wherein step of comparing the semantic relatedness further comprises:
estimating relatedness and depth between the inquired proposal and the expert name list and the expert publications of the academic field of the inquired proposal by checking catalog structure of the semantic network in the expert knowledge database; and
generating the expert list according to the relatedness and the depth thereof.
